(19) United States
(12) Patent Application Publication
(10) Pub. No.: US 2008/0093835 A1
(43) Pub. Date: Apr. 24, 2008

(54) Reversible writing pad

(76) Inventor: Kurt Sward, Deerfield, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/516,072

(22) Filed: Sep. 6, 2006

(51) Int. Cl. B42D 1/00; B42D 3/00; B42D 5/00

(52) U.S. Cl. 281/21.1; 281/29; 281/38

(57) ABSTRACT

The present invention generally provides a writing pad. The writing pad has a grouping of pages of paper, a generally rigid backing substrate for supporting the grouping of pages of paper, and a connector rotatably connecting the backing substrate to the grouping of pages of paper. The grouping of pages of paper has a first side, a second side and an edge, and the pages of the grouping of pages of paper are joined toward the edge thereof. Further, since the connector is rotatably connected to the backing substrate, the connector allows the backing substrate to be rotated about the edge of the grouping of pages of paper such that both sides of the pages of paper can be written on at different times with a supporting backing substrate thereunder. Preferably, individual pages of paper can be removed from the grouping.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a pad of paper, and more specifically to a writing pad having a reversible backer to allow the user to write on both sides of the writing material.

### BACKGROUND OF THE INVENTION

Writing tablets, including paper pads, are well known in the art. While such writing pads according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a writing pad. According to one embodiment the writing pad comprises a grouping of pages of paper, a generally rigid backing substrate for supporting the grouping of pages of paper, and a connector rotatably connecting the backing substrate to the grouping of pages of paper. The grouping of pages of paper has a first side, a second side and an edge, and the pages of the grouping of pages of paper are joined toward the edge thereof. Further, since the connector is rotatably connected to the backing substrate, the connector allows the backing substrate to be rotated about the edge of the grouping of pages of paper such that both sides of the pages of paper can be written on at different times with a supporting backing substrate thereunder. Preferably, individual pages of paper can be removed from the grouping.

According to another embodiment, a binding is provided to secure the pages of pages of paper together. In such an embodiment the connector may rotatably connect the backing substrate to the binding.

According to another embodiment, the connector has a first end and a second end, the first end being attached to the backing substrate and the second end being attached to the grouping of pages of paper.

According to another embodiment, the connector comprises a first connector and a second connector. In such an embodiment, the first connector is secured to the backing and the first side of the grouping of pages of paper, and the second connector is secured to the backing and the second side of the grouping of pages of paper.

According to another embodiment, the writing pad comprises a plurality of pages of paper having a first surface and a second surface, a backing substrate for supporting the plurality of pages of paper, a first connector and a second connector. In this embodiment the first connector has a first portion operably fixedly attached to the first surface of the plurality of pages of paper, a second portion operably fixedly attached to the backing substrate, and a flexible portion therebetween, and the second connector similarly has a first portion operably fixedly attached to the second surface of the plurality of pages of paper, a second portion operably fixedly attached to the backing substrate, and a flexible portion therebetween. Typically, in this embodiment the first connector surrounds the second connector when the backing substrate is in a first position.

According to another embodiment, when two connectors are utilized, the first connector and the second connector have generally the same length. According to another embodiment, however, the first and second connectors may have a different length.

According to another embodiment, the writing pad comprises a grouping of pages of paper, the grouping having a first side, a second side and an edge; a backing substrate for supporting the grouping of pages of paper, the backing substrate having a first side and a second side; a binding on the grouping of pages of paper; and, a connector rotatably connecting the backing substrate to the grouping of pages of paper to allow the backing substrate to be rotated about the edge of the grouping from a first position wherein generally the entire first side of the grouping of pages of paper lie substantially flat on the first side of the backing substrate, to a second position wherein generally the entire second side of the grouping of pages of paper lie substantially flat on the second side of the backing substrate; and wherein the backing is connected to the grouping of pages of paper in the first position, the second position, and in a transition from the first position to the second position.

According to yet another embodiment, the connector is pleated to either compress or expand dependent on the position of the grouping of paper relevant to the backing substrate.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a partial perspective view of one embodiment of a reversible writing pad;

FIG. 2 is a partial cross-sectional side view about line 2-2 of the reversible writing pad of FIG. 1 with the backing substrate in a first position;

FIG. 3 is a partial cross-sectional side view of the reversible writing pad of FIG. 1 with the backing substrate in transition from the first position to a second position;

FIG. 4 is a partial cross-sectional side view of the reversible writing pad of FIG. 1 with the backing substrate in the second position;

FIG. 5 is an exploded partial cross-sectional side view of the reversible writing pad of FIG. 1;

FIG. 6 is a partial cross-sectional side view of another embodiment of a reversible writing pad with the backing substrate in a first position;

FIG. 7A is a partial cross-sectional side view of the reversible writing pad of FIG. 6 with the backing substrate in transition from the first position to a second position;

FIG. 7B is a partial cross-sectional side view of the reversible writing pad of FIG. 6 with the backing substrate in transition from the first position to a second position;

FIG. 7C is a partial cross-sectional side view of the reversible writing pad of FIG. 6 with the backing substrate in transition from the first position to a second position;

FIG. 7D is a partial cross-sectional side view of the reversible writing pad of FIG. 6 with the backing substrate in transition from the first position to a second position;

FIG. 8 is a partial cross-sectional side view of the reversible writing pad of FIG. 6 with the backing substrate in the second position;

FIG. 9 is a partial cross-sectional perspective view of the reversible writing pad of FIG. 1 with a supplemental connector; and

FIG. 10 is a partial cross-sectional side view about line 10-10 of the reversible writing pad of FIG. 9.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

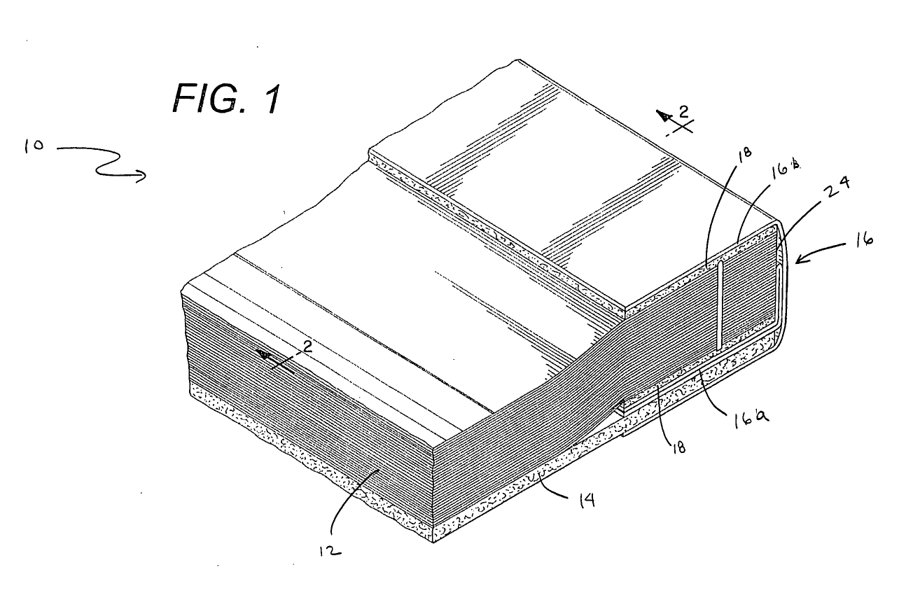

Referring now to the Figures, and specifically to FIGS. 1-4, there is shown a reversible writing pad 10. The writing pad 10 generally comprises a grouping of pages of paper 12, a backing substrate 14 for supporting the grouping of pages of paper 12, and a connector 16 for securing the backing 14 to the grouping of pages of paper 12 and further to allow the backing substrate 14 to be rotated about an edge 24 of the grouping of pages of paper 12 to transition from a first position to a second position to allow a user to write on both sides of each page of paper while having a rigid backing member for support. Additionally, in alternate embodiments of the writing pad 10 a binding member 18 is provided on one or more sides of the grouping of pages of paper 12, and in further alternate embodiment first and second connectors 16a and 16b are provided.

In one embodiment of the writing pad 10 the grouping of pages of paper 12 comprises a plurality of sheets of paper joined together in a grouping. For clarification, the term paper as used herein defines any material or component that is adapted to be written on, including but not limited to paper substrate, plastic substrate, etc. The grouping of pages of paper 12 has a first side or surface 20, a second side or surface 22 opposing the first side 20, and an edge 24. Generally, the grouping of pages of paper 12 are joined together using readily known techniques toward the edge 24 of the grouping of pages of paper 12. Additionally, it is understood that individual sheets may be removed from the grouping 12 without interfering with the integrity of the writing pad 10. While individual sheets of paper may be removed from the grouping 12, including the outside sheets of paper, the grouping 12 will maintain the same general first side 20 and second side 22 regardless of the number of sheets of paper remaining in the grouping 12 or removed from the grouping 12.

Referring to FIG. 1, in one embodiment the plurality of paper 12 is generally rectangular in shape, having a size such as standard paper size (8.5″×11.0″) or legal size (8.5″×14.0″), however, one of ordinary skill in the art would readily understand that the grouping of paper 12 may have any size or shape without departing from the scope of the present invention.

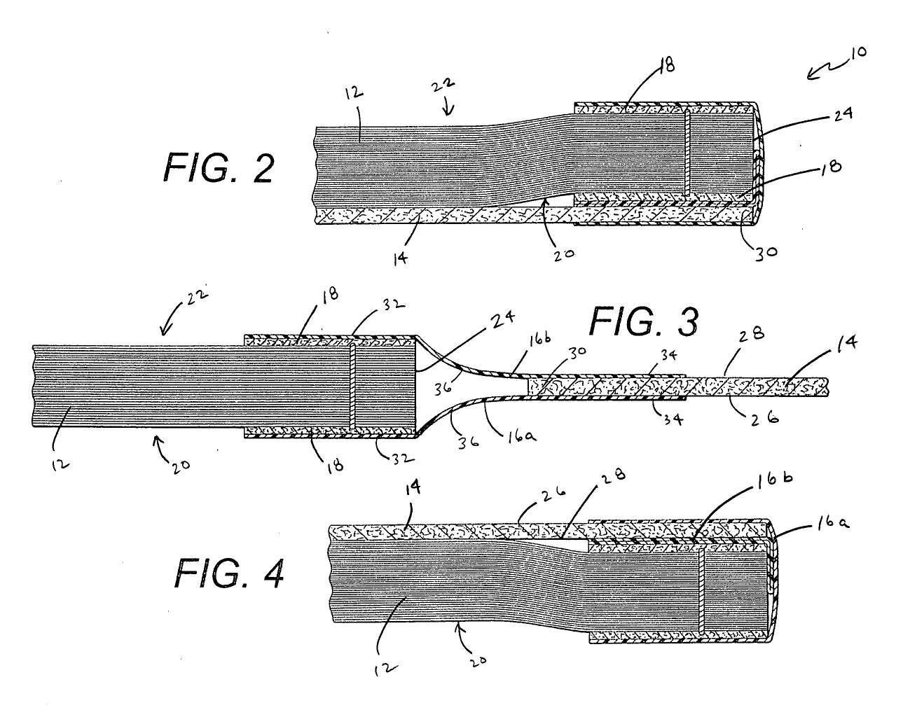

In one embodiment, a binding member 18 is provided on one or more sides of the grouping of pages of paper 12, while in alternate embodiments a binding member 18 is not necessary. The binding member 18 may assist in securing the pages of paper 12 together, or it may be provided to assist in securing the connector 16 to the grouping of pages of paper 12. In a preferred embodiment the binding member 18 comprises a strip of material, such as chipboard or a more rigid paperboard that is secured to a surface of the grouping of pages of paper 12 adjacent the edge 24 of the grouping of pages of paper 12. Referring to FIG. 2, one binding member 18 may be provided on the first side 20 of the grouping of pages of paper 12, and another binding member 18 may be provided on the second side 22 of the grouping of pages of paper 12. Conversely, referring to FIG. 6, the binding member 18 wraps around the edge 24 of the grouping of pages of paper 12, extending from the first side 20 of the grouping of pages of pager 12 to the second side 22 of the grouping of pages of paper 12.

The backing substrate 14 generally comprises a generally rigid member for supporting the grouping of pages of paper 12 for the writing pad 10 when a user is writing on one of the pages of paper 12. Accordingly, the backing substrate 14 is preferably sized with a geometric correlation to the size of the plurality of paper 12 of the writing pad 10. Preferably, the backing substrate 14 has generally the same shape and size, but not necessarily the same depth component, as the grouping of pages of paper 12. Additionally, the backing substrate 14 has a first side 26 and a second side 28 opposing the first side 26, as well as a first end 30. In one embodiment the first end 30 of the backing substrate 14 is evenly positioned with the edge 24 of the plurality of paper 12. In a preferred embodiment the backing substrate 14 is formed from chipboard, cardboard or other similar material as known in the art, however, it is understood that the backing substrate 14 may be formed from any generally rigid material. The backing substrate can be rotated or flipped from the opposing sides of the grouping of pages of paper of the writing pad 10 to provide the user with support when writing on either the first or second sides of the one of the pages of paper.

As explained above, the writing pad 10 also contains a connector 16 for securing the backing 14 to the grouping of pages of paper 12. In preferred embodiments the connector 16 rotatably secures the backing 14 to the grouping of pages of paper 12 to allow the backing 14 to be rotated from a first position, wherein the first side 26 of the backing 14 is adjacent the first side or surface 20 of the grouping of pages of paper 12 (see FIGS. 1, 2 and 6), to a second position, wherein the second side 28 of the backing 14 is adjacent the second side or surface 22 of the grouping of pages of paper 12 (see FIGS. 4 and 8). Preferably, in the first position the first side 20 of the grouping of pages of paper 12 lies generally flat on the first side 26 of the backing substrate 14, and in the second position the second side 22 of the grouping of pages of paper 12 lies generally flat on the second side 28 of the backing substrate 14. The connector 16 is made of any flexible material known in the art, however, preferred embodiments utilize a flexible Tyvek® material.

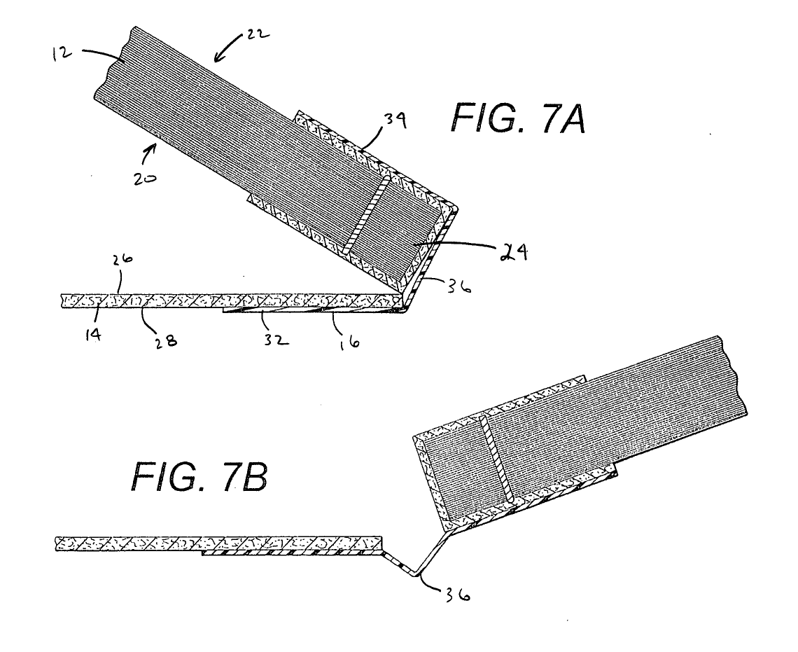

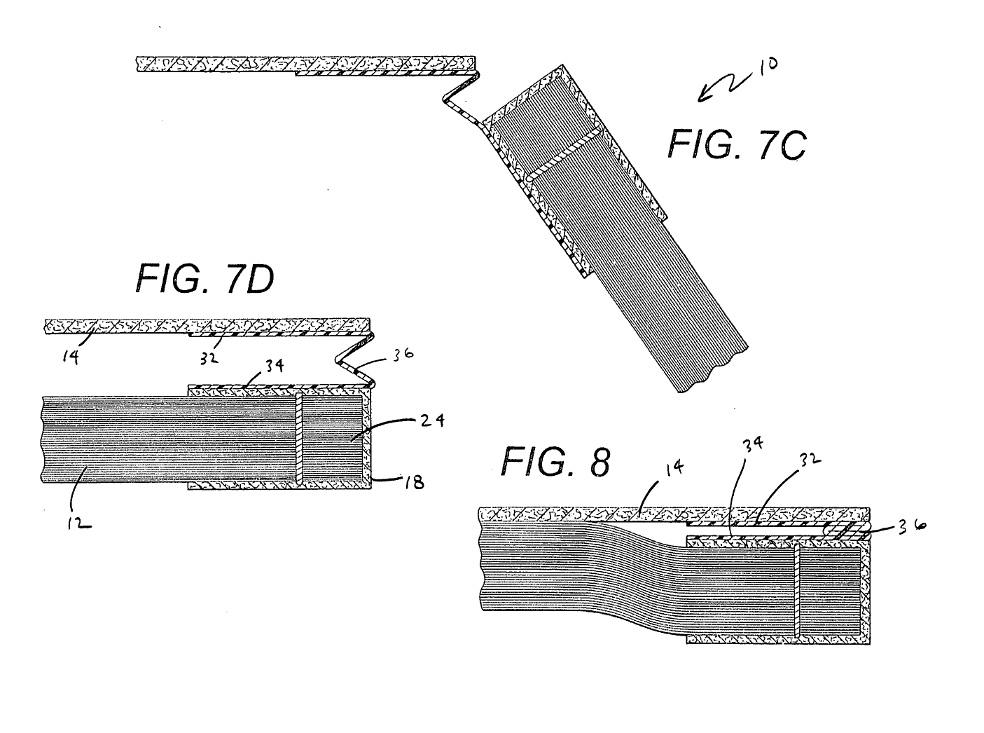

Referring to all embodiments, the connector 16 has a first portion 32 at generally a first end 32 and a second portion 34 at generally a second end 34. The first portion 32 is operably connected, preferably fixedly, to the grouping of pages of paper 12 of the writing pad 10, and the second portion 34 is attached, and preferably fixedly attached, to the backing substrate 14. The connector 16 also has a flexible portion 36 between the first and second ends 32, 34 thereof. Having a connector 16 with a flexible portion 36 allows the backing substrate 14 to transition from the first position to the second position, and in one embodiment to be rotated about the edge 24 of the grouping of pages of paper 12, while being connected to the grouping of pages of paper 12, either directly or indirectly in connection with a binding member 18, during the entire transition and thereafter. For example, in one embodiment the writing pad 10 is shown with the backing 14 in the first position is FIG. 2, and the second position in FIG. 4. In this embodiment the transition of the backing 14 from the first position to the second position is illustrated in FIG. 3. Similarly, in another embodiment (FIGS. 6-8) writing pad 10 is shown with the backing 14 in the first position in FIG. 6, in the second position in FIG. 8, and in the transition from the first position to the second position in FIGS. 7A through 7D.

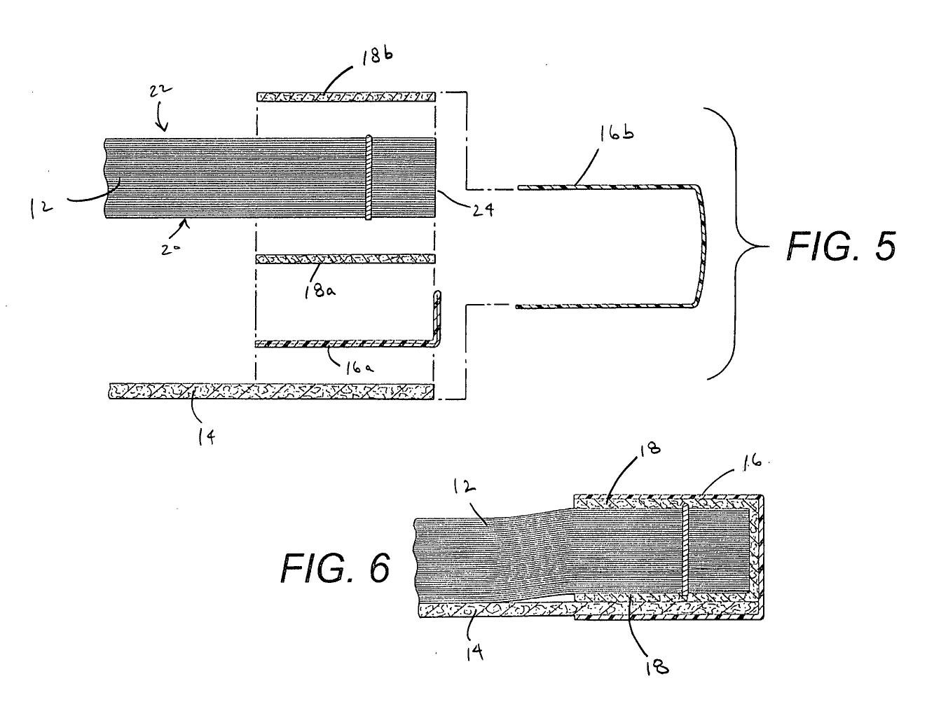

In the embodiment of FIGS. 1-5 the writing pad 10 has two connectors, including a first connector 16a and a second connector 16b. The first connector 16a has a first portion 32 at generally a first end 32, a second portion 34 at generally a second end 34, and a flexible portion 36 between the first end 32 and the second end 34. As shown in FIG. 3, the first portion 32 of the first connector 16a is operably connected, preferably fixedly, to the first side 20 of the grouping of pages of paper 12 of the writing pad 10, and the second portion 34 of the first connector 16a is attached, and preferably fixedly attached, to the first side 26 of the backing substrate 14. Similarly, the second connector 16b has a first portion 32 at generally a first end 32, a second portion 34 at generally a second end 34, and a flexible portion 36 between the first end 32 and the second end 34. Referring again to FIG. 3, the first portion 32 of the second connector 16b is operably connected, preferably fixedly, to the second side 22 of the grouping of pages of paper 12 of the writing pad 10, and the second portion 34 of the second connector 16b is attached, and preferably fixedly attached, to the second side 28 of the backing substrate 14.

As shown in FIG. 3, in one embodiment the first connector 16a and the second connector 16b have generally the same length. When backing substrate 14 of the writing pad 10 is in the first position (FIGS. 1 and 2), the first side 26 of the backing substrate 14 is adjacent the first side 20 of the grouping of pages of paper 12, thereby providing support for the writing pad 10 and allowing the user to write on the second side 22 of any of the pages of paper in the writing pad 10. In this position the first connector 16a is generally visible, and the second connector 16b is generally in a folded position and is contained and surrounded by the first connector 16a. Conversely, when the backing substrate 14 of the writing pad 10 is in the second position (FIG. 4), the second side 28 of the backing substrate 14 is adjacent the second side 22 of the grouping of pages of paper 12, thereby also providing support for the writing pad 10 but allowing the user to write on the first side 20 of any of the pages of paper in the writing pad 10. In this position the second connector 16b is generally visible, and the first connector 16a is generally in a folded position and is contained and surrounded by the second connector 16b.

In an alternate embodiment, as explained above, the writing pad 10 also comprises at least one binding member 18. The binding member 18 may be provided to assist in securing the pages of paper 12 together, or it may be provided to assist in securing the connector 16 to the grouping of pages of paper 12. As shown in FIGS. 2-5, a first binding member 18a is provided on the first side 20 of the grouping of pages of paper 12, and a second binding member 18b is provided on the second side 22 of the grouping of pages of paper 12. Alternatively, as shown in FIG. 6, a single binding member 18 may be provided and wrapped around the grouping of pages of paper 12, thereby extending from the first side 20 of the grouping 12 to the second side 22 of the grouping 12, generally around the edge 24 of the grouping 12. As shown in FIGS. 2-5, the first end 32 of the first connector 16a is secured to the outer surface of the first binding member 18a, and the first end 32 of the second connector 16b is secured to the outer surface of the second binding member 18b. In a preferred embodiment the binding member 18 comprises a strip of material, such as chipboard or a more rigid paperboard that is secured to a surface of the pages of paper 12 adjacent the edge 24 of the grouping of pages of paper 12.

Referring to FIGS. 6-8, an embodiment of the writing pad 10 having a single elongated connector 16 is shown. In this embodiment the writing pad 10 is shown in the first position in FIG. 6, in the second position in FIG. 8, and in transition from the first position to the second position in FIGS. 7A through 7D. It is understood that in all embodiments the backing member 14 rotates from the first position to the second position, and also back from the second position to the first position. In the first position in this embodiment the first side 26 of the backing member 14 is adjacent the first side 20 of the grouping of pages of paper 12, and in the second position the second side 28 of the backing member 14 is adjacent the second side 22 of the grouping of pages of paper 12. Additionally, in this embodiment a binding member 18 is provided that extends from the first side 20 of the pages of paper 12, over the edge 24 and onto the second side 22 of the pages of paper 12. As explained above, the binding member 18 need not be included. The second portion 34 of the connector 16 of this embodiment is connected to the second side 28 of the backing member 14, and the first portion 32 of the connector 16 is connected to the outer surface of the binding member 18 on the second side 22 of the grouping of pages of paper 12. Thus, in the first position the connector extends from the second side 22 of the grouping of pages of paper 12, around the edge 24 of the grouping of pages of paper 12, and onto the second side 28 of the backing member 14. To transition the backing member 14 from the first position to the second position the backing member 14 is rotated about the edge 24 of the grouping of pages of paper 12 via the flexible connector 16. Because of the configuration of this embodiment, in the second position the first portion 32 of the connector 16 is adjacent the second portion 34 of the connector 16. Additionally, in this embodiment the flexible middle portion 36 of the connector 16 is preferably pleated to lie appropriately. Thus, in this embodiment when the plurality of paper 12 is in a first position the connector 16 is unfolded, and when the plurality of paper 12 is in the second position the connector 16 is folded.

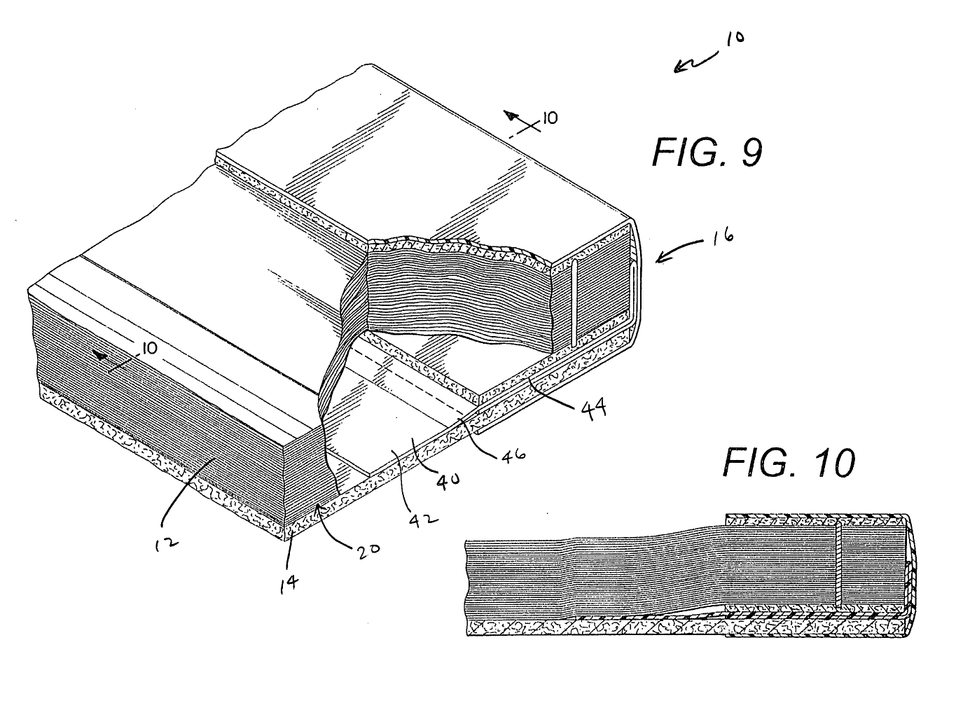

Referring to FIGS. 9-10, and additional embodiment is provided having a supplemental connector 40. The supplemental connector 40 is a component that secures the backing member 14 in the first position and against first side 20 of the grouping of pages of paper 12 until the user desires to have the backing member 14 rotate to the second position such that the second side 28 of the backing substrate 14 is adjacent the second side 22 of the grouping of pages of paper 12. In one embodiment, the supplemental connector 40 has a first portion 42, a second portion 44 and a tearable portion 46 therebetween. The tearable portion 46 may also be referred to as a perforation or serration portion in that the tearable portion 46 may have an area susceptible to separation.

In one embodiment the first portion 42 of the supplemental connector 40 is connected to the grouping of pages of paper 12 of the writing pad 10 and the second portion 44 of the supplemental connector 40 is connected to the backing substrate 14. In a preferred embodiment as shown in FIGS. 9 and 10, the supplemental connector 40 is an extension of the connector 16 of the writing pad 10.

In use, the supplemental connector 40 maintains a connection between the grouping of pages of paper 12 and the backing substrate 14 to keep the backing substrate 14 in a fixed position, thereby not allowing the backing substrate 14 to rotate until a sufficient force is applied to separate the first and second portions 42, 44 of the supplemental connector 40. After a sufficient force is applied and the first and second portions 42, 44 of the supplemental connector 40 are separated, the backing substrate 14 is free to rotate between the first and second positions.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A writing pad comprising:
a grouping of pages of paper, the grouping having a first side, a second side and an edge, the grouping of pages of paper being joined toward the edge thereof;
a backing substrate for supporting the grouping of pages of paper; and,
a connector rotatably connecting the backing substrate to the grouping of pages of paper to allow the backing substrate to be rotated about the edge of the grouping.

2. The writing pad of claim 1, further comprising a supplemental connector connecting the backing substrate to the grouping of pages of paper and securing the backing substrate in a first position to prevent rotation of the backing substrate, the supplemental connector further having a perforation adapted to separate the supplemental connector into first and second portions to allow the backing substrate to be rotated about the edge of the grouping following separation of the supplemental connector at the perforation.

3. The writing pad of claim 2, wherein the supplemental connector is an extension of one end of the connector.

4. The writing pad of claim 1, further comprising a binding securing the pages of pages of paper together, the connector rotatably connecting the backing substrate to the binding securing the pages of paper together.

5. The writing pad of claim 1, wherein the backing is generally rigid.

6. The writing pad of claim 1, wherein the connector is fixedly attached to the grouping of pages of paper.

7. The writing pad of claim 1, wherein the connector has a first end and a second end, the first end being attached to the backing substrate and the second end being attached to the grouping of pages of paper.

8. The writing pad of claim 1, wherein the connector comprises a first connector and a second connector, the first connector being secured to the backing and the first side of the grouping of pages of paper, and the second connector being secured to the backing and the second side of the grouping of pages of paper.

9. The writing pad of claim 4, wherein the connector comprises a first connector and a second connector, the first connector being secured to the backing and the binding adjacent the first side of the grouping of pages of paper, and the second connector being secured to the backing and the binding adjacent the second side of the grouping of pages of paper.

10. The writing pad of claim 1, wherein individual pages of paper can be removed from the grouping.

11. A writing pad comprising:
a plurality of pages of paper, the plurality having a first surface and a second surface;
a backing substrate for supporting the plurality of pages of paper;
a first connector having a first portion operably fixedly attached to the first surface of the plurality of pages of paper, a second portion operably fixedly attached to the backing substrate, and a flexible portion therebetween; and,
a second connector having a first portion operably fixedly attached to the second surface of the plurality of pages of paper, a second portion operably fixedly attached to the backing substrate, and a flexible portion therebetween.

12. The writing pad of claim 11, wherein the first connector surrounds the second connector when the backing substrate is in a first position.

13. The writing pad of claim 11, wherein the first connector and the second connector have generally the same length.

14. The writing pad of claim 11, further comprising a binding to secure the plurality of pages of paper together, the binding provided on the first surface of the plurality of pages of paper and the second surface of the plurality of pages of paper, the first portion of the first connector being fixedly attached to the binding secured to the first surface of the plurality of pages of paper, and the first portion of the second connector being fixedly attached to the binding secured to the second surface of the plurality of pages of paper.

15. The writing pad of claim 11, further comprising a supplemental connector connecting the backing substrate to the plurality of pages of paper and securing the backing substrate in a first position to prevent rotation of the backing substrate, the supplemental connector further having a perforation adapted to separate the supplemental connector into first and second portions to allow the backing substrate to be rotated about the edge of the grouping following separation of the supplemental connector at the perforation.

16. A writing pad comprising:
a grouping of pages of paper, the grouping having a first side, a second side and an edge;
a backing substrate for supporting the grouping of pages of paper, the backing substrate having a first side and a second side;
a binding on the grouping of pages of paper; and,
a connector rotatably connecting the backing substrate to the grouping of pages of paper to allow the backing substrate to be rotated about the edge of the grouping from a first position wherein generally the entire first side of the grouping of pages of paper lie substantially flat on the first side of the backing substrate, and a second position wherein generally the entire second side of the grouping of pages of paper lie substantially flat on the second side of the backing substrate, and wherein the backing is connected to the grouping of pages of paper in the first position, the second position, and in a transition from the first position to the second position.

17. The writing pad of claim 16, wherein the connector is rotatably connected at one end to the backing substrate and at another end to the binding to secure the pages of paper together.

18. The writing pad of claim 16, wherein the connector comprises a first connector having a first portion fixedly attached adjacent the first side of the grouping of pages of paper, a second portion fixedly attached to the backing substrate, and a flexible portion therebetween, and a second connector having a first portion fixedly attached adjacent the second side of the grouping of pages of paper, a second portion fixedly attached to the backing substrate, and a flexible portion therebetween.

19. The writing pad of claim 16, wherein the first connector and the second connector have generally the same length.

20. The writing pad of claim 16, wherein the binding is provided on the first side and the second side of the grouping of pages of paper.

21. The writing pad of claim 16, wherein the binding extends from the first side of the grouping of pages of paper to the second side of the grouping of pages of paper, the first portion of the first connector being fixedly attached adjacent a first side of the binding, and the first portion of the second connector being fixedly attached adjacent a second side of the binding.

22. The writing pad of claim 16, wherein the connector is pleated to either compress or expand dependent on the position of the grouping of paper relevant to the backing substrate.
